(19) United States
(12) Patent Application Publication
(10) Pub. No.: US 2011/0281182 A1
(43) Pub. Date: Nov. 17, 2011

(54) FUEL ANALYZING METHOD AND FUEL ANALYZING DEVICE FOR FUEL CELL, AND FUEL CELL

(75) Inventors: Hideki Sakai, Kanagawa (JP); Taiki Sugiyama, Kanagawa (JP); Hideyuki Kumita, Kanagawa (JP); Ryuhei Matsumoto, Kanagawa (JP)

(73) Assignee: SONY CORPORATION, Tokyo (JP)

(21) Appl. No.: 13/085,701

(22) Filed: Apr. 13, 2011

(30) Foreign Application Priority Data
May 11, 2010 (JP) 2010-109234

(51) Int. Cl. H01M 8/16

(52) U.S. Cl. 429/401

(57) ABSTRACT

Disclosed herein is a fuel analyzing method for a fuel cell, including the steps of: measuring a physical property and/or an electric characteristic of a fuel to be used in a biofuel cell having an electrode with an oxidoreductase present at a surface thereof; and determining the quantity of an effective component which contributes to power generation in the fuel, from the physical property and/or the electric characteristic.

### BACKGROUND OF THE INVENTION

1. Field of the Invention

The present invention relates to a fuel analyzing method for a biofuel cell in which an oxidoreductase is used, a fuel analyzing device using the method, and a biofuel cell including the device. More specifically, the invention relates to a technology for detecting the quantity of a component which is contained in a fuel and which contributes to power generation, namely, the quantity of an effective component.

2. Description of the Related Art

Biofuel cells in which an oxidoreductase is used as a reaction catalyst are advantageous in that electrons can be efficiently taken out from a fuel which cannot be utilized with ordinary industrial catalysts, such as glucose and ethanol. In view of this, the biofuel cells are expected as next-generation fuel cells high in capacity and safety. FIG. 6 shows a reaction scheme of a biofuel cell in which an enzyme is used. For example, in the case of a biofuel cell using glucose as a fuel, as shown in FIG. 6, an oxidation reaction of glucose proceeds and electrons are taken out at a negative electrode (anode), whereas a reduction reaction of oxygen (O₂) in air proceeds at a positive electrode (cathode).

While gaseous fuels and liquid fuels can be used in the biofuel cell, aqueous solutions of solid fuels such as glucose and commercial beverages (sugar-containing soft drinks and alcoholic drinks, etc.) can also be used in the biofuel cells. In this case, the residual capacity and the power generation quantity of the cell should be known from the concentration of an effective component which contributes to power generation, such as glucose and ethanol.

On the other hand, in methanol-type fuel cells and generators, in general, the residual quantity of the fuel source is determined from the quantity (volume) of the liquid fuel such as methanol and gasoline. Hitherto, there have been proposed fuel cells in which a fuel container is provided with a window for checking the residual amount of the fuel (see, for example, Japanese Patent Laid-open Nos. 2005-158592, 2006-313735, and 2006-173006). Besides, in primary cells and secondary cells, the residual electric capacity is predicted by use of an electrochemical characteristic of the cell.

### SUMMARY OF THE INVENTION

However, the related art as above-mentioned involves the following problem. In a biofuel cell, other components than the effective component contributing to power generation are contained in the fuel, and the quantity of the solution in the cell is not reduced even upon consumption of the effective component due to power generation. Therefore, it may be impossible, by only measuring the quantity (volume) of the liquid, to accurately estimate the residual capacity.

Besides, in the case of a biofuel cell which is a kind of generator, additional pouring of fuel is possible. In this case, solutions differing in effective component concentration are mixed with each other, so that it may be more difficult to estimate the residual capacity, even if an electrochemical characteristic at the time of power generation is measured. Further, although a method in which a sensor capable of direct measurement of the concentration of an effective component such as glucose (biosensor) is used may be contemplated, this method is not suited to measurement of a fuel that contains an effective component in a high concentration. An attempt to obviate this problem leads to a complicated cell structure.

Thus, there is a need for provision of a fuel analyzing method and a fuel analyzing device for a fuel cell and a fuel cell such that the quantity of an effective component in a fuel to be used in a biofuel cell can be detected, without complicating the cell configuration.

According to an embodiment of the present invention, there is provided a fuel analyzing method for a fuel cell, including the steps of: measuring a physical property and/or an electric characteristic of a fuel to be used in a biofuel cell having an electrode with an oxidoreductase present at a surface thereof; and determining the quantity of an effective component which contributes to power generation in the fuel, from the physical property and/or the electric characteristic.

Here, the surface of the electrode includes wholly the outer surfaces of the electrode and the inner surfaces of voids in the inside of the electrode. This applies hereinafter.

In this embodiment of the invention, the quantity of the effective component in the fuel is determined from a physical property and/or an electric characteristic of the fuel. Therefore, the cell configuration is not complicated.

This fuel analyzing method may further include a step of calculating the output and/or capacity of the biofuel cell from the quantity of the effective component.

In addition, at least one selected from the group composing of viscosity, refractive index, angle of rotation of light, absorbance and current may be measured.

According to another embodiment of the present invention, there is provided a fuel analyzing device for a fuel cell, including: a measuring section operable to measure a physical property and/or an electric characteristic of a fuel to be used in a biofuel cell having an electrode with an oxidoreductase present at a surface thereof; a fuel inlet section for introducing a fuel as an object of measurement into the measuring section; and a fuel outlet section for discharging the fuel having been subjected to measurement in the measuring section.

In this fuel analyzing device, at least one detector selected from the group composing of a viscometer, a sugar content meter, a spectroscope and a biosensor may be provided in the measuring section.

In addition, a configuration may be adopted in which the fuel inlet section is connected to a fuel tank, and the fuel outlet section is connected to the fuel cell, the fuel tank or a waste liquid tank.

According to a further embodiment of the present invention, there is provided a fuel cell which includes the above-mentioned fuel analyzing device.

This fuel cell may include: one or a plurality of cell sections having an electrode with an oxidoreductase present at a surface thereof; a fuel tank filled with the fuel to be poured into the cell section or sections; and a fuel supply section which is provided between the cell section or sections and the fuel tank and which is operable to supply the fuel in the fuel tank into the cell section or sections; and the fuel analyzing device may be disposed in the fuel supply section.

In the above-mentioned embodiments of the present invention, the quantity of an effective component in the fuel is determined from the physical property and/or the electric characteristic. Accordingly, the residual capacity of the cell and the power generation quantity of the fuel can be predicted (estimated), without complicating the cell configuration.

### BRIEF DESCRIPTION OF THE DRAWINGS

FIG. 1 shows a flowchart for a capacity and output deciding method for a biofuel cell based on the use of a fuel analyzing method according to a first embodiment of the present invention;

FIG. 2 schematically illustrates the configuration of a fuel analyzing apparatus according to a second embodiment of the present invention;

FIG. 3 schematically illustrates a condition where a biofuel cell is equipped with the fuel analyzing apparatus shown in FIG. 2;

FIG. 4 schematically illustrates the configuration of a biofuel cell according to a third embodiment of the present invention;

FIG. 5 schematically illustrates the principle of power generation in the biofuel cell shown in FIG. 4; and

FIG. 6 shows a reaction scheme of a biofuel cell in which an enzyme is used.

### DETAILED DESCRIPTION OF THE PREFERRED EMBODIMENTS

Now, embodiments of the present invention will be described in detail below, referring to the accompanying drawings. Incidentally, the present invention is not limited to the following embodiments. Besides, the description will be made in the following order.

### 1. First Embodiment

(an example of a method for detecting an effective component in a fuel to be used in a biofuel cell)

### 2. Second Embodiment

(an example of a fuel analyzing apparatus for a fuel cell)

### 3. Third Embodiment

(an example of a biofuel cell provided with the fuel analyzing apparatus)

### 1. First Embodiment

### [Analyzing Method]

First, a fuel analyzing method for a biofuel cell according to a first embodiment of the present invention will be described. In the fuel analyzing method of the present embodiment, a physical property and/or an electric characteristic of a fuel to be used in a biofuel cell having an electrode with an oxidoreductase at a surface thereof is measured, and the content of an effective which contributes to power generation is determined from the result of measurement.

### [Fuel]

The fuel as an analyte in this embodiment is not particularly limited, and its state may be solid, liquid or gaseous. Specific examples of the fuel include solutions containing an effective component such as glucose, ethanol, oxygen, etc., gaseous fuels such as ethanol vapor, hydrogen, etc., and solid fuels such as lump sugar. Further, in the biofuel cells, gel-like or solid foods such as a jelly as well as commercial beverages can also be used as the fuel, and these can also be analyzed by the fuel analyzing method according to this embodiment.

### [Measurement]

In addition, the measurement of a physical property and/or an electric characteristic of the fuel is carried out (a) before pouring the fuel into the cell section or sections, (b) at the time of pouring the fuel into the cell section or sections, (c) in the inside of the cell, or in combination of these modes. For example, in the case where the residual capacity of the biofuel cell is predicted, a physical property or an electric characteristic of the fuel reserved in the cell section(s) is measured. Besides, in the case where it is desired to know the power generation quantity (the quantity of the effective component) regarding a fuel before use, it suffices to conduct the measurement before or at the time of pouring the fuel into the cell section(s).

Examples of the physical property to be measured include viscosity, refractive index, absorbance, specific gravity and angle of rotation. Examples of the electric characteristic include current. Further, the liquid quantity or volume of the fuel may also be measured, together with the physical property and the electric characteristic.

Incidentally, the physical properties such as sugar content, viscosity and absorbance do not directly indicate the quantity of an effective component. Though the measured value of physical property can be used as it is for simple decision, the measured value is desirably corrected in the case where a more accurate quantity of the effective component should be known. Examples of the method for correction in such a case include a method in which the liquid quantity or volume of the fuel is measured, and the physical property value is corrected based on the measured value of the liquid quantity or volume. Regarding a commercial beverage or the like on which the quantities of components are labeled, the correction may be carried out referring to the labeled values.

On the other hand, in the case of a method in which the quantity of an effective component is determined from the absorbance of the fuel, a specific reference substance may be contained in the fuel, or an already contained substance may be utilized as a reference substance. Where the measured value is corrected based on a peak intensity or the like of the reference substance, a more accurate quantity of the effective component can be determined.

### [Capacity and Output Deciding Method]

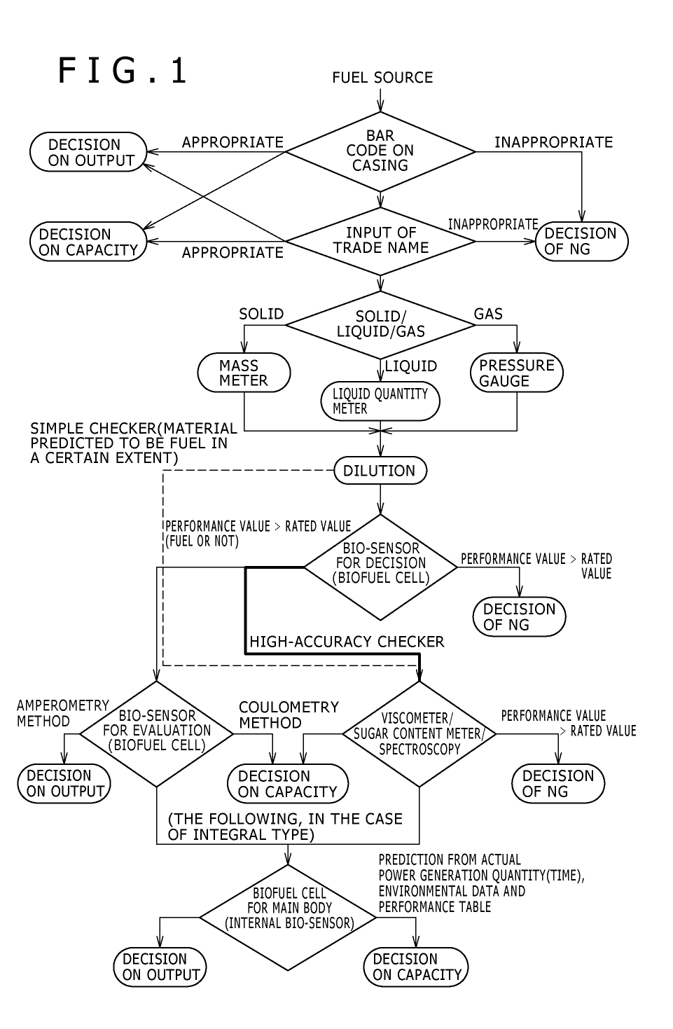

Now, a method for deciding the capacity and output and the like of a biofuel cell by use of the above-described fuel analyzing method will be described below, taking as an example the case in which a commercial beverage is used as a fuel. FIG. 1 is a flowchart for a method of deciding the capacity and output of a biofuel cell by use of the fuel analyzing method according to the present embodiment. In the case where a commercial beverage is used as a fuel, first, as shown in FIG. 1, a bar code appended to the container (casing) is read to examine whether or not the beverage is applicable as a fuel, that is, whether or not the beverage contains an effective component.

In addition, a system may be adopted in which a database on a product-by-product basis is separately prepared in advance so that components contained in the beverage product can be searched by the trade name of the beverage product. When it is qualified, as a result of the examination or search, that the object product does not contain any effective component, the product is decided to be “no good for use (NG).” When the beverage product contains an effective component, the product is decided to be “good for use.”

In this case, if the data on the product includes the concentration of the effective component, “decision on output” and “decision on capacity” in the case where the beverage is used as a fuel may be made, as well. Besides, in the case where physical properties and electric characteristics and the like items are preliminarily measured and data on the contained components as well as their contents and capacity density (Wh/ml) are given in a database form, an exclusive-use standard format code such as QR code or the like may be read by the a detector equipped with reader, thereby downloading these data to carry out “decision on output” and “decision on capacity.”

Further, other than the data on the effective components, data on things containing obstacles to an enzyme reaction and things causing a trouble when used in combination may be recorded in the database; in this case, decision of “no good for use (NG)” is made if the fuel as the object of measurement is relevant to the thus recorded data. This makes it possible to prevent the use of materials which are inappropriate for use as a fuel.

Thereafter, the quantity of the fuel is measured by a mass meter, a liquid quantity meter or a pressure gauge according as the fuel is solid, liquid or gaseous. The fuel, after being diluted if necessary, is poured into the biofuel cell.

In the case where a fuel is further added after the above-mentioned pouring of the fuel, the physical property or electric characteristic as to the fuel added at the time of additional pouring into the cell section(s) or as to the whole fuel inclusive of the added fuel in the cell section(s) is measured. In this case, if simplified decision suffices, the viscosity or sugar content (refractive index, specific gravity, or angle of rotation) or absorbance of the fuel is measured by a viscometer, a sugar content meter or a spectroscope or the like. When the measurement result is out of preset values or range, decision of “no good for use (NG)” is made. When the measurement result is within the preset values (range), the cell capacity is calculated based on the measurement result.

Next, in regard of a fuel for which the measurement result is within the preset values (range), the cell capacity is calculated based on the measurement result, as required. Specifically, by use of a bio-sensor in which for example glucose oxidase is immobilized on an electrode, a chemical-potential or thermal or optical change due to reaction with glucose is detected as an electrical signal. Then, based on the result of this, an output or a more accurate cell capacity is predicted. In this case, a more accurate cell capacity can be predicted by use of a bio-sensor of a cell structure having both a fuel electrode and an air electrode.

In addition, the bio-sensor can be used in other cases than the case where a fuel not containing any effective component is additionally poured into the biofuel cell. For instance, in the case where a fuel containing an inhibitor for the enzyme reaction or a fuel ill-compatible with the previously poured fuel is additionally poured, the added fuel can be detected by the bio-sensor. This ensures that, even in such a case, the decision of “no good for use (NG)” can be made easily and securely. In this case, if the enzyme to be used at the air electrode is immobilized on the electrode in addition to the enzyme to be used at the fuel electrode, a material inhibitive to the reaction at the air electrode can also be detected.

Further, in the case where it is desired to predict the output and capacity of the biofuel cell more accurately, measurement of an electric characteristic by a bio-sensor may be carried out before the measurement of a physical property such as viscosity and/or instead of the measurement of the physical property. For instance, in the case where whether or not a fuel can be used is decided by a bio-sensor for decision and thereafter measurement regarding the usable fuel is carried out by a bio-sensor instead of the measurement of a physical property, decision on “output” is carried out by the amperometry method, and decision on “capacity” is carried out by the coulometry method. In this case, naturally, a bio-sensor of the above-mentioned cell structure can be used.

Incidentally, these measurements may be conducted for the fuel yet to be poured into the biofuel cell. However, these measurements may be performed immediately before the fuel is poured into the cell section(s), by a viscometer or a sugar content meter or a spectroscopy that is provided between the fuel tank and the cell section(s), for example. Further, measurement for the fuel in the cell section(s) may be carried out during power generation and/or during stop of power generation, by a bio-sensor provided at the cell section(s). This makes it possible to know the residual capacity of the cell. In this instance, for example where the quantity of the fuel in the cell section(s) is small, discarding of the fuel sampled for measurement would greatly affect the residual capacity. In such a case, it suffices for the cell capacity (power generation quantity) corresponding to the sampled fuel to be subtracted from the power generation quantity relevant to the original fuel.

Incidentally, in order to know the cell capacity more accurately, it is desirable that, in addition to the capacity for the fuel before power generation, the capacity for the fuel in power generation and the actual total power generation quantity (integrated value) be measured and calculated on a real-time basis, irrespectively of whether the power generation is being stopped or being carried out. This permits early finding of fuel leakage or fuel deterioration. Besides, in the fuel analyzing method according to this embodiment, the quantity of the effective component can be indirectly determined from both the concentrations of other components than the fuel such as coloring matter or caffeine which are acquired from the database and the measured value of current or absorbance, and, by using the indirectly determined values together with the values determined directly from the measurement as above-mentioned, the capacity and output can be predicted.

Furthermore, use of these measurement results together with a temperature sensor, a pH sensor and a reference electrode or the like makes it possible to achieve discrimination between run-out of fuel, reversible deterioration of cell performance (fuel exhaustion near the electrode, insufficient supply of oxygen and/or protons, etc) and irreversible deterioration (thermal denaturation of enzyme, breakage of internal member, etc.). Consequently, it is possible to realize a system by which the user can be informed of an optimum action for coping with the symptom of a problem, such as addition of fuel, starting of a pump, stirring and replacement of the internal solution, replacement of the cell itself or a part thereof, etc.

Thus, in the fuel analyzing method for the biofuel cell according to the present embodiment, the physical property and/or the electric characteristic of the fuel is measured by a physicochemical and/or electrochemical technique. Therefore, the quantity of an effective component in a fuel to be used in the biofuel cell can be determined, without complicating the cell configuration. Further, by using the physical property measurement and the electric characteristic measurement in combination, the output and capacity of the cell can be predicted more accurately.

### 2. Second Embodiment

### [General Configuration]

Now, a fuel analyzing device for a biofuel cell according to a second embodiment of the present invention will be described below. The fuel analyzing device in this embodiment is designed to measure a physical property and/or an electric characteristic of a fuel to be used in a biofuel cell having an electrode with an oxidoreductase present at a surface thereof, and to determine the quantity of an effective component in the fuel, based on the results of measurement.

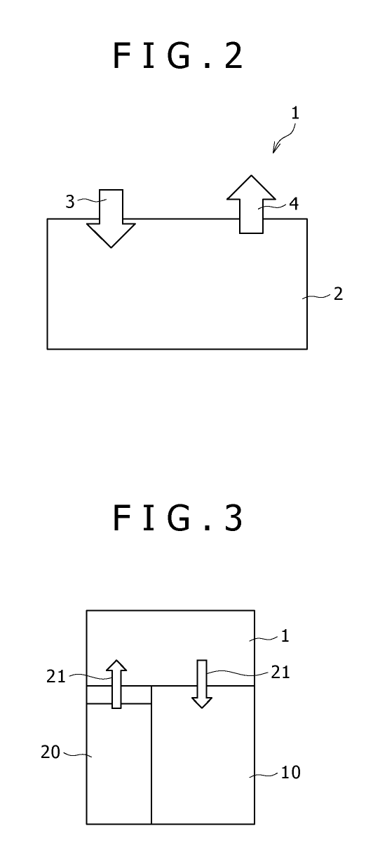

FIG. 2 schematically illustrates the configuration of the fuel analyzing device according to the present embodiment. As shown in FIG. 2, the fuel analyzing device 1 in this embodiment has a measuring section 2 operable to measure a physical property and/or an electric characteristic of the fuel, a fuel inlet section 3 for introducing the fuel as an object of measurement into the measuring section 2, and a fuel outlet section 4 for discharging the fuel having undergone the measurement.

### [Measuring Section 2]

At least one of physical property measuring instruments such as a sugar content meter, a viscometer, a spectroscope, etc. and electric characteristic measuring instruments such as a biosensor, etc. is provided in the measuring section 2. Examples of the sugar content meter which can be used here include a refractive sugar content meter for obtaining sugar content from refractive index, an optical rotation sugar content meter for obtaining sugar content from the angle of rotation of light transmitted through a solution as an object of measurement, and a near infrared sugar content meter for irradiating with near infrared rays and obtaining sugar content from the degree of absorption of the rays. It is to be noted here, however, that this type of meter is applicable only to the case where the effective component as an object of detection is sucrose.

The viscometer is not specifically restricted. Examples of the viscometer which can be used here include a capillary viscometer, a falling-ball viscometer, a rotation viscometer, an oscillation viscometer, a plane parallel plate viscometer, and bubble viscometer. In addition, the biosensor may be appropriately selected according to the effective component which is the object of detection. For example, in the case where the effective component is glucose, use can be made of a biosensor in which glucose oxidase is immobilized on an electrode and a chemical-potential, thermal or optical change due to reaction of glucose oxidase with glucose can be detected as an electrical signal.

Further, the measuring section 2 may be so configured that its part for contact with a fuel can directly pierce a fruit or vegetable, or may have such a length that it can cope with a situation even where there is some distance from an inlet of the container to the fuel in the container.

### [Decision Section, Display Section, etc.]

In addition, the fuel analyzing device 1 may be provided with a decision section for predicting, based on a physical property and/or an electric characteristic of a fuel, the capacity or output of the biofuel cell when a solution of the fuel is used in the cell. Further, the fuel analyzing device 1 may be provided with a display section for displaying the results of prediction. Incidentally, the fuel analyzing device 1 in this embodiment may be provided, in addition to the above-mentioned functions, with a function for recording and displaying a history, a function of predicting the serviceable life of the cell, a function of displaying a discarding method, a voltage measuring function, or the like.

### [Operation]

Now, operation of the fuel analyzing device 1 according to the present embodiment will be described below. The fuel analyzing device 1 in this embodiment is a device for detecting an effective component in a fuel by the fuel analyzing method according to the above-described first embodiment, and is used either independently or integrally with a biofuel cell. In this case, the fuel analyzing device 1 may be used with the fuel outlet section 4 connected, for example, to a fuel tank, a waste liquid tank or a fuel pouring port of the biofuel cell. Besides, in the case of using the fuel analyzing device 1 independently, an appropriate amount of a fuel as an object of measurement is sampled from a fuel tank or a beverage container, and is introduced into the measuring section 2 through the fuel inlet section 3.

Thereafter, in the measuring section 2, a physical property such as viscosity, sugar content, absorbance, etc. of the fuel and/or an electric characteristic such as current is measured. Then, the fuel having undergone the measurement is discharged through the solution outlet section 4. In this case, the fuel having undergone the measurement may be returned into the fuel tank or may be introduced into the waste liquid tank or the fuel pouring port of the biofuel cell, according to the results of measurement.

Thus, before pouring a fuel into the biofuel cell, a physical property and/or an electric characteristic of the fuel is preliminarily measured to thereby determine the quantity of an effective component in the fuel. This ensures that whether the fuel is usable or not can be decided before pouring the fuel into the biofuel cell. In addition, even in the case of pouring a fuel into a plurality of cells, a large number of measurements can be carried out in a short time. Further, even a fuel prepared by a child by mixing a plurality of materials can be analyzed easily. Furthermore, the analyzing device can be reduced in size easily and can be repaired and replaced easily.

FIG. 3 schematically illustrates a condition in which the fuel analyzing device 1 shown in FIG. 2 is mounted to a biofuel cell. On the other hand, in the case where the fuel analyzing device 1 is used integrally with a biofuel cell 10, as shown in FIG. 3, the fuel inlet section 3 is connected to a fuel tank 20 filled with a fuel yet to be used, whereas the solution outlet section 4 is connected to a fuel pouring port of the biofuel cell 10. In other words, a configuration is set in which the fuel 21 contained in the fuel tank 20 is poured into the biofuel cell 10 through the fuel analyzing device 1. In this case, a configuration in which the fuel having undergone measurement is introduced into a waste liquid tank or a configuration in which the fuel having undergone measurement is returned into the fuel tank 20 may also be adopted.

Thus, immediately before the fuel is poured into the biofuel cell, a physical property and/or an electric characteristic of the fuel is measured to thereby determine the quantity of an effective component in the fuel, whereby the measurement can be performed in a real-time mode. In addition, a combination of this with other various parameters enables a more accurate measurement.

As above-mentioned, in the fuel analyzing device for a biofuel cell according to the present embodiment, a physical property and/or an electric characteristic of a fuel is measured by a physicochemical and/or an electrochemical technique, and the quantity of an effective component in the fuel is determined from the measurement results. Therefore, the cell configuration would not be complicated. In addition, the output and capacity of the biofuel cell in the case where the fuel is used in the cell can also be predicted from the value(s) obtained by the measurement(s).

### 3. Third Embodiment

### [General Configuration]

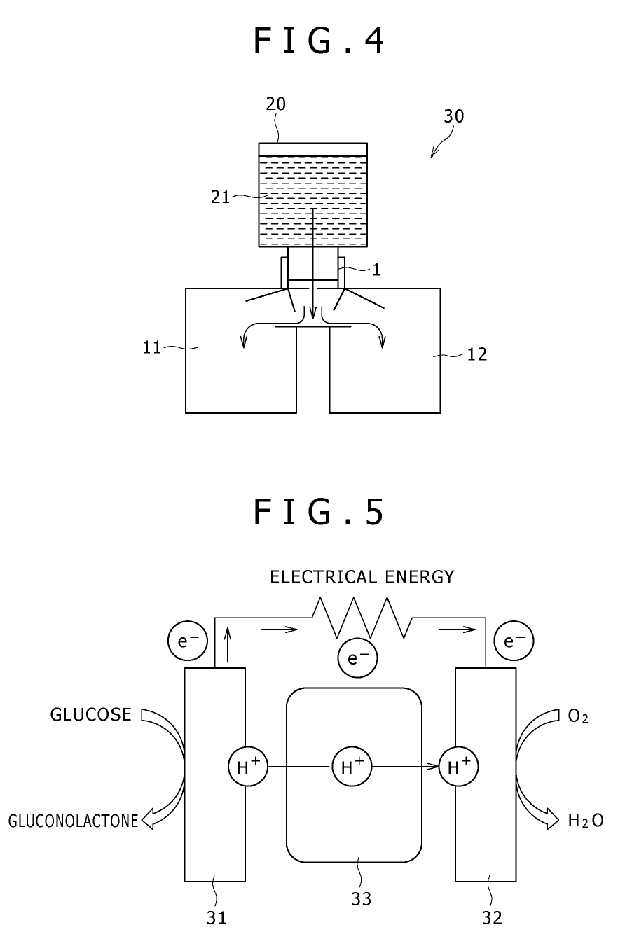

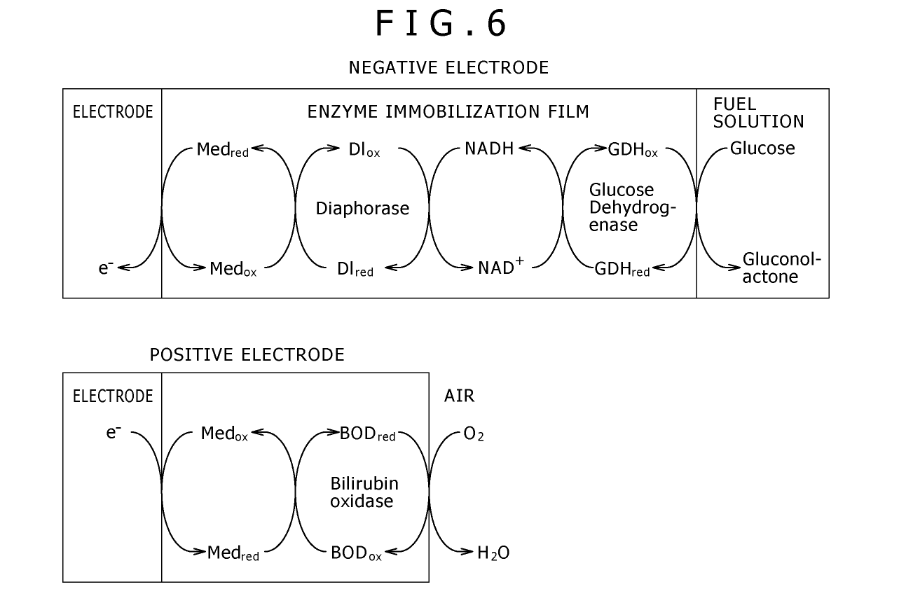

Now, a biofuel cell according to a third embodiment of the present invention will be described below. FIG. 4 is a conceptual illustration of the configuration of a biofuel cell according to the present embodiment, and FIG. 5 schematically illustrates the principle of power generation therein. As shown in FIG. 4, the biofuel cell 30 in this embodiment has two cell sections 11 and 12, and a fuel is supplied from a single fuel tank 20 into the two cell sections 11 and 12. Besides, a fuel supply section 13 provided between the fuel tank 20 and the cell sections 11, 12 is provided with the fuel analyzing device 1 according to the second embodiment described above.

### [Cell Sections 11, 12]

Each of the cell sections 11, 12 may, for example, have a configuration in which, as shown in FIG. 5, an anode 31 and a cathode 32 are disposed opposite to each other, with a protonic conductor 33 therebetween. As the anode 31, there can be used, for example, an electrode which is formed from a conductive porous material and on a surface of which an oxidoreductase is immobilized. As the cathode 32, there can be used, for example, an electrode which is formed from a conductive porous material and on a surface of which an oxidoreductase and an electron mediator are immobilized. Here, the surface of the electrode include wholly the outer surfaces of the electrode and the inner surfaces of voids in the inside of the electrode. This applies hereinafter.

In the case of this configuration, at the anode 31, a fuel is decomposed by an enzyme immobilized on the electrode surface, thereby taking out electrons and producing protons (H⁺). On the other hand, at the cathode 32, water (H₂O) is produced from the proton (H⁺) transported from the anode 31 through the protonic conductor 33, the electron (e⁻) sent from the anode 31 through an external circuit, and oxygen (O₂) present in air, for example.

In addition, as the conductive porous material for forming the anode 31, known materials can be used. Particularly preferred are carbon materials, such as porous carbon, carbon pellet, carbon felt, carbon paper, laminate of carbon fibers or carbon particulates, etc. Further, as the enzyme immobilized on the surface of the anode, for example in the case where the fuel is glucose, there can be used glucose dehydrogenase (GDH) by which glucose is decomposed.

Furthermore, in the case where monosaccharide such as glucose is used as the fuel, a coenzyme oxidase and/or an electron mediator is desirably immobilized on the surface of the anode 31, in addition to the oxidase which accelerates oxidation of the monosaccharide such as GDH to thereby decompose the monosaccharide. The coenzyme oxidase is for oxidizing a coenzyme which is reduced by an oxidase (for example, NAD⁺, NADP⁺, etc.) and a reduced coenzyme (for example, NADH, NADPH, etc.). Examples of the coenzyme oxidase include diaphorase. When the coenzyme is retuned to the oxidized form under the action of the coenzyme oxidase, electrons are produced. The electrons thus produced are transferred from the coenzyme oxidase to the electrode through the electron mediator.

As the electron mediator, there is preferably used a compound having a quinone skeleton, particularly, a compound having a naphthoquinone sleleton. Specific examples of such a compound include 2-amino-1,4-naphthoquinone (ANQ), 2-amino-3-methyl-1,4-naphthoquinone (AMNQ), 2-methyl-1,4-naphthoquinone (VK3), and 2-amino-3-carboxy-1,4-naphthoquinone (ACNQ). As the compound having the quinone skeleton, not only the compounds having the naphthoquinone skeleton but also anthraquinone and its derivatives can be used, for example. Further, if necessary, together with the compound having the quinone ekeleton, one or more other compounds which act as electron mediator may be immobilized on the anode surface.

In the case where a polysaccharide is used as the fuel, a breakdown enzyme capable of accelerating decomposition (e.g., hydrolysis) of the polysaccharide to produce a monosaccharide such as glucose is desirably immobilized on the anode surface, in addition to the above-mentioned oxidase, coenzyme oxidase, coenzyme and electron mediator. Incidentally, the term “polysaccharides” here is used in a wide meaning, namely, is used to mean all the carbohydrates capable of producing two or more monosaccharide molecules through hydrolysis, and it include oligosaccharides such as disaccharides, trisaccharides, tetrasaccharides, etc. Specific examples of the polysaccharide include starch, amylose, amylopectin, glycogen, cellulose, maltose, sucrose, and lactose. These have two or more monosaccharides bonded to each other. Every one of the polysaccharides contains glucose as the monosaccharide serving as bonding units.

Besides, amylose and amylopectin are components contained in starch; in other words, starch is a mixture of amyloze and amylopectin. For example, in the case where glucoamylase is used as a breakdown enzyme for polysaccharides and where glucose dehydrogenase is used as an oxidase for monosaccharides, polysaccharides capabe of being decomposed to glucose by glucoamylase can be used as fuel. Examples of such polysaccharides include starch, amylose, amylopectin, glycogen, and maltose. Here, glucoamylase is a breakdown enzyme for hydrolyzing α-glucan such as starch to produce glucose, and glucose dehydrogenase is an oxidase for oxidizing β-D-glucose to D-glucono-δ-lactone.

On the other hand, as the conductive porous material for forming the cathode 32, also, known materials can be used, of which particularly preferred are carbon materials such as porous carbon, carbon pellet, carbon felt, carbon paper, laminate of carbon fibers or carbon particulates, etc. Examples of the oxygen reductase to be immobilized on the cathode include bilirubin oxidase, laccase, and ascorbate oxidase. Besides, examples of the electron mediator to be immobilized together with the enzyme include potassium hexacyanoferrate, potassium ferricyanide, and potassium octacyanotungstate.

Further, the protonic conductor 33 may be any material which does not have electronic conductivity and which is capable of transporting protons (H⁺). Examples of such a material include cellophane, galatin, and ion exchange resins having a fluorine-containing carbonsulfonate group. Besides, electrolytes can also be used as the protonic conductor.

Incidentally, the electrodes provided in the cell sections 11, 12 are not limited to those having the oxidoreductase immobilized on the surface thereof, insofar as the oxidoreductase is present at the electrode surface. Specifically, electrodes such that microorganism having an oxidoreductase is deposited on the surface thereof and such that the above-mentioned actions are realized at the anode 31 and the cathode 32 can also be used.

### [Fuel Tank 20]

The fuel tank 20 is filled with the fuel 21 to be supplied to the cell sections 11, 12. The shape, internal volume, material and the like of the fuel tank 20 are not particularly restricted. It is desirable, however, that for example a part or the whole part of the fuel tank 20 is formed from a transparent or light-colored material so that the status (the liquid quantity or the like) in the inside of the fuel tank 20 can be visually checked.

In addition, the fuel 21 reserved in the fuel tank 20 and to be supplied into the cell sections 11, 12 is an effective component or components such as sugars, alcohols, aldehydes, lipids, proteins, etc. or a liquid or solid or the like containing at least one of such effective components. Examples of the effective component in the fuel to be used in the biofuel cell according to this embodiment include sugars such as glucose, fructose, sorbose, etc., alcohols such as methanol, ethanol, propanol, glycerin, polyvinyl alcohol, etc., aldehydes such as formaldehyde, acetaldehyde, etc., and organic acids such as acetic acid, formic acid, pyruvic acid, etc. Other than these materials, there can also be used fats, proteins, organic acids which are intermediate products of sacchrometabolism of fats and proteins, and the like, as the effective component.

### [Operation]

Now, operation of the biofuel cell 30 according to the present embodiment will be described below. In the biofuel cell 30 in this embodiment, the fuel 21 contained in the fuel tank 20 is subjected to measurement of a physical property and/or an electric characteristic thereof in the fuel analyzing device 1 provided at the fuel supply section 13, before being poured into the cell sections 11, 12.

Then, based for example on the results of detection at the fuel analyzing device 1, the supply of the fuel to the cell sections 11, 12 is permitted or inhibited. For instance, when the quantity of the effective component detected at the fuel analyzing device 1 is out of preset values (range), the solution outlet section 4 of the fuel analyzing device 1 is closed or the fuel supply port for the cell sections 11, 12 is closed, thereby inhibiting the solution in the fuel analyzing device 1 from flowing into the cell sections 11, 12. Or, alternatively, flow paths may be switched over so that the solution flows into a waste liquid tank (not shown).

As above-mentioned, in the biofuel cell 30 according to the present embodiment, the fuel analyzing device 1 is disposed at the fuel supply section 13 provided between the fuel tank 20 and the cell sections 11, 12. This configuration ensures that the quantity of an effective component in the fuel can be easily determined, without complicating the cell structure.

Incidentally, while the configuration according to this embodiment is applicable to biofuel cells of a structure in which a plurality of cell sections are connected in series or in parallel, the configuration naturally is applicable also to biofuel cells of a “monocell” structure in which a single cell section is provided. In addition, the configuration and operation of the fuel analyzing device 1 are the same as described in the second embodiment above.

The present disclosure contains subject matter related to that disclosed in Japanese Priority Patent Application JP 2010-109234 filed in the Japan Patent Office on May 11, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A fuel analyzing method for a fuel cell, comprising the steps of:
measuring a physical property and/or an electric characteristic of a fuel to be used in a biofuel cell having an electrode with an oxidoreductase present at a surface thereof; and
determining the quantity of an effective component which contributes to power generation in the fuel, from the physical property and/or the electric characteristic.

2. The fuel analyzing method for the fuel cell according to claim 1, further comprising a step of
calculating an output and/or a capacity of the biofuel cell, from the quantity of the effective component.

3. The fuel analyzing method for the fuel cell according to claim 1, wherein at least one selected from the group composing of viscosity, refractive index, angle of rotation of light, absorbance and current is measured.

4. A fuel analyzing device for a fuel cell, comprising:
a measuring section operable to measure a physical property and/or an electric characteristic of a fuel to be used in a biofuel cell having an electrode with an oxidoreductase present at a surface thereof;
a fuel inlet section for introducing a fuel as an object of measurement into the measuring section; and
a fuel outlet section for discharging the fuel having been subjected to measurement in the measuring section.

5. The fuel analyzing device for the fuel cell according to claim 4, wherein at least one detector selected from the group composing of a viscometer, a sugar content meter, a spectroscope and a biosensor is provided in the measuring section.

6. The fuel analyzing device for the fuel cell according to claim 4, wherein the fuel inlet section is connected to a fuel tank, and the fuel outlet section is connected to the fuel cell, the fuel tank or a waste liquid tank.

7. A fuel cell comprising
the fuel analyzing device, including:
a measuring section operable to measure a physical property and/or an electric characteristic of a fuel to be used in a biofuel cell having an electrode with an oxidoreductase present at a surface thereof;
a fuel inlet section for introducing a fuel as an object of measurement into the measuring section; and
a fuel outlet section for discharging the fuel having been subjected to measurement in the measuring section.

8. The fuel cell according to claim 7, comprising:
one or a plurality of cell sections having an electrode with an oxidoreductase present at a surface thereof;
a fuel tank filled with the fuel to be poured into the cell section or sections; and
a fuel supply section which is provided between the cell section or sections and the fuel tank and which is operable to supply the fuel in the fuel tank into the cell section or sections;
wherein the fuel analyzing device is disposed in the fuel supply section.
